(19) United States
(12) Patent Application Publication
(10) Pub. No.: US 2015/0325854 A1
(43) Pub. Date: Nov. 12, 2015

(54) STRUCTURE OF ELECTRODE FOR ALL-SOLID-STATE BATTERIES

(71) Applicant: HYUNDAI MOTOR COMPANY, Seoul (KR)

(72) Inventors: Won Keun KIM, Suwon-si (KR); Kyoung Han RYU, Yongin-si (KR)

(21) Appl. No.: 14/569,533

(22) Filed: Dec. 12, 2014

(30) Foreign Application Priority Data
May 8, 2014 (KR) 10-2014-0055051

(51) Int. Cl. H01M 4/485; H01M 4/583; H01M 4/58; H01M 4/36; H01M 4/48

(52) U.S. Cl. CPC H01M 4/485; H01M 4/366; H01M 4/483; H01M 4/58; H01M 4/5815; H01M 4/5825; H01M 4/583; H01M 10/0525

(57) ABSTRACT

An electrode of an all-solid-state battery has an ionic conductive coating active material and an electronically conductive coating active material. Based on a thickness of the electrode, 50% of the electrode near a current collector is V_{B}>V_{A} and remaining portions close to a solid electrolyte are V_{A}>V_{B}, where V_{A} is a volume of the ionic conductive coating active material, and V_{B} is a volume of the electronically conductive coating active material.

### CROSS-REFERENCE TO RELATED APPLICATION

This application claims the benefit of priority to under 35 U.S.C. §119(a) the benefit of Korean Patent Application No. 10-2014-0055051 filed on May 8, 2014, the entire contents of which are incorporated herein by reference. cl TECHNICAL FIELD

The present disclosure relates to a structure of an electrode for an all-solid-state battery having improved electrochemical properties, and a method of manufacturing the same.

### BACKGROUND

In recent years, there have been increasing demands for an eco-friendly vehicle compared to a conventional vehicle which operates by an internal combustion engine using gasoline and diesel as main fuel. A hybrid vehicle which operates by a combination of an electric motor with the internal combustion engine and an electric car which operates by the electric motor have been developed and available to the public.

In the hybrid and electric vehicles, a rechargeable secondary storage battery is essential to drive the electric motor. In general, the conventional secondary storage battery uses a liquid electrolyte for a lithium ion battery, and thus, there are problems such as liquid leakage.

The lithium-ion battery has been used as a power source for portable devices such as notebook computers and mobile phones, but ignition or explosion have been frequently reported. In particular, when the secondary storage battery is mounted on the car, there has been an urgent need for securing of safety since the secondary storage battery is used under more severe operating conditions than the secondary storage battery mounted on these portable devices, and the energy capacity also has increased.

Accordingly, an all-solid-state battery having all main members made of solid including an electrolyte has been developed. Since the electrolyte is not liquid in the all-solid-state battery, the risks of liquid leakage, ignition, and explosion are greatly reduced as compared to the conventional secondary storage battery.

In particular, it is possible to charge and discharge a high voltage of 3 to 5V while using a nonflammable solid electrolyte, thus increasing safety of using the all-solid-state lithium secondary battery. An electrode of a general liquid electrolyte-based battery has a structure shown in FIG. 1 in which conductive materials are uniformly dispersed within the electrode, and a liquid electrolyte is impregnated, thereby being advantageous for conduction of electrons and lithium ions.

However, in order to improve safety and volumetric energy density of the liquid electrolyte based-battery with low stability, electrodes of the solid electrolyte based all-solid-state battery have been developing. An electrode of an all-solid-state battery has a structure as shown in FIG. 2, i.e., a composite electrode structure in which the solid electrolyte material is mixed with the electrode in an amount of 50% or less in order to provide an effect of impregnation of the liquid electrolyte.

However, the lithium ion conductivity of the solid electrolyte material itself is lower than the liquid electrolyte, and a porosity of the electrode is high even if it is designed in the structure of FIG. 2

The conductivity of lithium ions, and electrochemical properties such as high rate discharge characteristics are improved by changing an electrode structure in the related art.

However, since there has been no consideration of electron conduction (a conductive material is used in a liquid electrolyte based-electrode structure for electron conduction), there is a need for development of an electrode structure in which all the conduction of electrons and lithium ions are considered for improvement in electrochemical properties of the electrode active material having basically low electron conductivity (LiCoO₂: 10⁻³ S/cm, LiMn₂O₄: 10⁻⁴ S/cm) and the all-solid-state battery.

The above information disclosed in this Background section is only for enhancement of understanding of the background of the invention, and therefore, it may contain information that does not form the prior art that is already known in this country to a person of ordinary skill in the art.

### SUMMARY OF THE DISCLOSURE

The present disclosure provides an electrode having a developed conduction structure of electrons and lithium ions, an all-solid-state battery having improved electrochemical properties, and a method of manufacturing the same.

According to an exemplary embodiment of the present inventive concept, an electrode of an all-solid-state battery comprises an ionic conductive coating active material and an electronically conductive coating active material. Based on a thickness of the electrode, 50% of the electrode near a current collector is V_{B}>V_{A} (V_{A} is a volume of the ionic conductive coating active material, and V_{B} is a volume of the electronically conductive coating active material), and remaining portions close to a solid electrolyte are V_{A}>V_{B}.

The electrode structure according to the present disclosure, an electrode structure that is advantageous for conduction of both electrons and lithium ions, by designing the electrodes by the electrode active material having the electronically conductive coating, and the electrode active material having the ionic conductive coating, and by increasing the ratio of the electronically conductive coating electrode active material on the electrode portion near the solid electrolyte interface, and increasing the ratio of ionic conductive coating electrode active material on the electrode portion close to the current collector.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure.

FIG. 1 is illustrates an electrode structure of a liquid electrolyte based battery.

FIG. 2 illustrates an electrode structure (left) of a common all-solid-state battery and an electrode structure (right).

FIG. 3 illustrates an all-solid-state battery electrode structure according to an exemplary embodiment of the present disclosure.

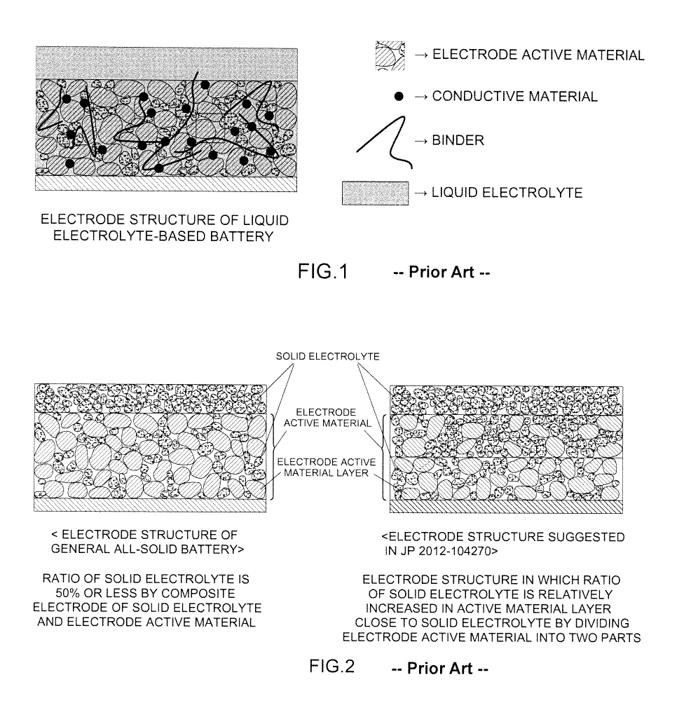

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present inventive concept, examples of which are illustrated in the accompanying drawings and described below. While the inventive concept will be described in conjunction with exemplary embodiments, it will be understood that present description is not intended to limit the inventive concept to those exemplary embodiments. On the contrary, the disclosure is intended to cover not only the exemplary embodiments, but also various alternatives, modifications, equivalents, and other embodiments, which may be included within the spirit and scope of the invention as defined by the appended claims.

The present disclosure provides an electrode of an all-solid-state battery constituted by an ionic conductive coating active material A and an electronically conductive coating active material B. Based on a thickness of the electrode, up to 50% of the electrode near a current collector is V_{B}>V_{A} (V_{A} is a volume of the active material A, and V_{B} is a volume of the active material B), and remaining portions near a solid electrolyte are V_{A}>V_{B}.

A represents an ionic conductive coating active material, and can be one or more species selected from the group consisting of glass-ceramic-based Li₂S—P₂S₅ (Li₂S:P₂S₅=50:50 to 100:0), Thio-Lisicon, Li₁₀GeP₂S₁₂, lithium lanthanum zirconate, lanthanum lithium titanate, lithium niobate, lithium phosphorus oxynitride, and lithium phosphate.

B represents an electronically conductive coating active material, and can be one or more species selected from the group consisting of conductive polymer (e.g., polypyrrole, polyacetylene, or the like), super C, Ketjen black, vapor grown carbon fiber, carbon nanotube, graphene, and precursors of these ingredients.

The active material A or B has a particle size of 0.05 to 30 μm (micrometers) and a thickness of coating of 1 to 100 nm.

The positive electrode active material may be layer structure based-lithium oxide, spinel structure-based lithium oxide, olivine structure-based lithium oxide, sulfur, or metal sulfide. The negative electrode active material may be a carbon-based material, a metal-based material, or a metal oxides-based material.

According the all-solid-state battery including the electrode, a lower conductive of the all-solid-state battery electrode structure layer is significantly improved by simultaneously applying the active materials having the ionic conductive coating and the electronically conductive coating as an electrode active material, and it is possible to provide an all-solid-state battery with high-density and high-power due to the improvement of the conductivity.

Manufacturing Example

Manufacturing of 50% of the electrode near the current collector is V_{B}>V_{A} (V is the volume of the active material), and remaining portions near the solid electrolyte are V_{A}>V_{B} based on thickness of the electrode will be described in the following.

Manufacturing of Material

1. LiCoO₂ having a solid electrolyte coating and a sulfide-based Li₂S—P₂S₅ solid electrolyte were combined at a ratio of 9:1 and subjected to heat treatment of 200 to 400° C., and then were homogenized.

2. LiCoO₂ having a carbon coating and a carbon material (e.g., Ketjenblack) were homogenized at a ratio of 9:1, and then were coated by high-energy ball milling.

Manufacturing of Electrode and Cell

1. LiCoO₂ having the carbon coating and LiCoO₂ having the solid electrolyte coating were mixed at a ratio of 7:3 on the current collector under a pressure of 10 MPa, and then a positive electrode active material layer having a thickness of 20˜30 μm was manufactured

2. LiCoO₂ having the carbon coating and LiCoO₂ having the solid electrolyte coating were mixed at a ratio of 3:7 on the current collector manufactured at 1 and the active material layer assembly under a pressure of 10 MP, and then a positive electrode active material layer having a thickness of 20˜30 μm was manufactured 3. The positive electrode active assemblies manufactured at 1 and 2 were assembled with a lithium anode and a solid electrolyte layer and were manufactured as a unit cell under a pressure of 10 MPa.

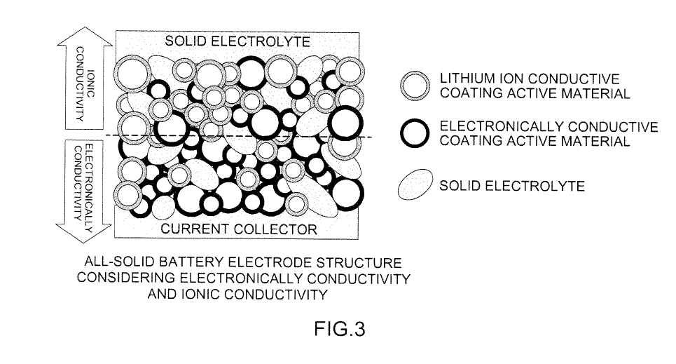

Table 1 shows an electrode comparison of FIG. 2 (comparative examples 1 and 2), and an output comparison between a discharge capacity of electrodes and an output of FIG. 3 (example)

TABLE 1

| | | Discharge | |
|---|---|---|---|
| | | capacity | Output |
| Classification | Positive electrode | (mAh/g) | (%, 0.2 C/0.05 C) |
| Comparative | SE + LiCoO₂ | 60 | 15 |
| Example 1 | | | |
| Comparative | SE gradient LiCoO₂ | 90 | 48 |
| Example 2 | | | |
| example | SE coated LiCoO₂ + | 105 | 72 |
| | Carbon coated LiCoO₂ | | |

The inventive concept has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An electrode of an all-solid-state battery comprising:
an ionic conductive coating active material and an electronically conductive coating active material,
wherein based on a thickness of the electrode, 50% of the electrode near a current collector is V_{B}>V_{A}, and remaining portions close to solid electrolyte are V_{A}>V_{B}, where V_{A} is a volume of the ionic conductive coating active material, and V_{B} is a volume of the electronically conductive coating active material.

2. The electrode of claim 1, wherein the ionic conductive coating active material is one or more species selected from the group consisting of glass-ceramic-based Li₂S—P₂S₅ (Li₂S:P₂S₅=50:50 to 100:0), Thio-Lisicon, Li₁₀GeP₂S₁₂, lithium lanthanum zirconate, lanthanum lithium titanate, lithium niobate, lithium phosphorus oxynitride, and lithium phosphate.

3. The electrode of claim 1, wherein the electronically conductive coating active material is one or more species selected from the group consisting of conductive, super C, Ketjenblack, vapor grown carbon fiber, carbon nanotube, graphene, and precursors of these ingredients.

4. The electrode of claim 1, wherein the ionic conductive coating active material or electronically conductive coating active material has a particle size of 0.05 to 30 μm and a thickness of coating of 1 to 100 nm, respectively.

5. The electrode of claim 1, wherein the positive electrode active material is lithium oxide having a layer structure, lithium oxide having a spinel structure, lithium oxide having an olivine structure, sulfur, or metal sulfide.

6. The electrode of claim 1, wherein the negative electrode active material is a carbon-based material, a metal-based material, or a metal oxides-based material.

7. An all-solid-state battery comprising the electrode according to claim 1.

8. An all-solid-state battery comprising the electrode according to claim 2.

9. An all-solid-state battery comprising the electrode according to claim 3.

10. An all-solid-state battery comprising the electrode according to claim 4.

11. An all-solid-state battery comprising the electrode according to claim 5.

12. An all-solid-state battery comprising the electrode according to claim 6.
